(19) United States
(12) Patent Application Publication
(10) Pub. No.: US 2025/0002725 A1
(43) Pub. Date: Jan. 2, 2025

(54) SIMPLE, SCALABLE METHOD FOR DISPERSING MXENES IN NONPOLAR ORGANIC SOLVENTS

(71) Applicant: CARNEGIE MELLON UNIVERSITY, Pittsburgh, PA (US)

(72) Inventors: Rahul PANAT, Pittsburgh, PA (US); Bin YUAN, Pittsburgh, PA (US)

(73) Assignee: CARNEGIE MELLON UNIVERSITY, Pittsburgh, PA (US)

(21) Appl. No.: 18/691,550

(22) PCT Filed: Oct. 25, 2022
(86) PCT No.: PCT/US2022/047689

§ 371 Date: Mar. 13, 2024

Related U.S. Application Data
(60) Provisional application No. 63/271,284, filed on Oct. 25, 2021.

(51) Int. Cl. C09C 1/36; B01J 13/00; B82Y 30/00; B82Y 40/00; C09C 3/00; C09C 3/04; C09C 3/08

(52) U.S. Cl. CPC C09C 1/3692; B01J 13/0026; C09C 3/006; C09C 3/045; C09C 3/08; B82Y 30/00; B82Y 40/00; C01P 2002/77; C01P 2004/04; C01P 2004/24

(57) ABSTRACT

The present disclosure is directed to simple, scalable methods of forming colloidal MXene dispersions in nonpolar organic solvents with long term stability.

### RELATED APPLICATIONS

This application claims the benefit of provisional application U.S. Ser. No. 63/271,284, filed Oct. 25, 2021, the contents of which is incorporated herein in its entirety.

### FIELD OF THE INVENTION

The present disclosure is directed to simple, scalable methods of forming colloidal MXene dispersions in nonpolar organic solvents with long term stability.

### BACKGROUND OF THE INVENTION

MXenes are an emerging class of two-dimensional nanomaterials that exhibit outstanding electrochemical properties and excellent electrical conductivity. This material has great potential for applications in the fields of electromagnetic interference shielding, energy storage, and membranes. Realizing these applications in industry may hinge on the large-scale production and dispersion-based bulk processing of MXenes, e.g., Ti₃C₂Tₓ MXene. In other words, large-scale synthesis of MXenes and their dispersion into polar and nonpolar solvents is of high importance. Specifically, dispersion of MXenes into nonpolar organic solvents can allow (i) broad and versatile solution processability suitable for various techniques such as three-dimensional (3D) printing, (ii) new functionalities, such as in-situ decoration of MXenes with various other functional nanomaterials such as catalysts, (iii) advanced MXene nanocomposites with atomic-level homogeneous distribution of MXene nanosheets in the matrix, and (iv) hybridizing functional MXene nanosheets with polymers.

Due in part to its intrinsic hydrophilicity originating from its surface functional groups (e.g., —OH and —F) and the inter-sheet electrostatic repulsive force stemming from its non-zero (negative) zeta potential, pristine Ti₃C₂Tₓ MXene nanosheets can be readily dispersed in several polar solvents, such as water, N,N-dimethylformamide, dimethyl sulfoxide, and propylene carbonate (Maleski et al. 2017, Chemistry of Materials 29:1632; Kim et al. 2021, Advanced Functional Materials 31:2008722). While water provides the best dispersibility, Ti₃C₂Tₓ MXene degrades rapidly and significantly in water (Zhang et al. 2017, Chemistry of Materials 29:4848).

As with other functional materials such as graphene, metal-organic frameworks, and quantum dots, providing dispersibility of Ti₃C₂Tₓ MXene in nonpolar organic solvents with varying physiochemical properties (e.g., boiling point, surface tension, and viscosity) offers many advantages, particularly since many industrial fabrication processes with these materials require solution processability.

Despite some progress, simple and rapid dispersion methods for Ti₃C₂Tₓ MXene and other MXenes in nonpolar organic solvents are still needed. For example, a few studies have demonstrated Ti₃C₂Tₓ MXene dispersion in nonpolar organic media through covalent surface functionalization (Park et al. 2022, Science Advances 8: eabl5299; Kim et al. 2019, ACS Nano 13:13818; Lee et al. 2021, ACS nano 15:19600; Heckler et al. 2021, Langmuir 37:5447). However, these processes can be lengthy (e.g., 0.5 to 1 day) and complicated (e.g. multiple steps with multiple components), and/or compromise Ti₃C₂Tₓ MXene intrinsic properties (for example, by consuming surface reactive moieties). One esterification method involves five chemical reagents with careful addition under an inert atmosphere (Lee et al. 2021) and another approach involves a lengthy (24 hour) aqueous reaction process, which could potentially lead to MXene degradation (Kim et al. 2019; Lim et al. 2019, Colloids and Surfaces A 579:123648). The route of covalently grafting polymer on MXene nanosheets also consumes surface functional groups while altering its electronic conductivity (Park et al. 2022).

While scalable synthesis of MXene has been demonstrated scalable methods (in liters/batch) for dispersing MXene in nonpolar organic solvents have yet to be developed (Shuck et al. 2020, Advanced Engineering Materials 22:1901241; Lim et al. 2022, Nature Synthesis 1:601). It is with this in mind that the present disclosure is provided.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

The present disclosure provides a simple and scalable method for rapid formation of MXene dispersions, for example, Ti₃C₂Tₓ MXene, in various nonpolar organic solvents with long-term colloidal and chemical stability without compromising the surface chemistry functionality of the MXene. For example, non-covalently capping the surface of the MXene nanosheets with certain ligands under ambient conditions can produce MXene dispersions in nonpolar organic solvents within 15 minutes in a single processing step at scales of one liter or more. In an embodiment herein, combining a paste of Ti₃C₂Tₓ MXene with an L-type ligand such as trioctylphosphine oxide (TOPO) in toluene followed by a short bath sonication provide a colloidal dispersion which is stable for more than a year with minimal to no oxidative degradation. Without wishing to be bound, it is believed that steric hindrance imparted by the TOPO bulky tail minimizes the van der Waals attractive force between the Ti₃C₂Tₓ MXene nanosheets. Because TOPO and the Ti₃C₂Tₓ MXene undergo a non-covalent coordination interaction, the intrinsic properties of Ti₃C₂Tₓ MXene are preserved and can be exploited.

Accordingly, disclosed herein are rapid, scalable methods for preparing a colloidal dispersion of two-dimensional planar MXenes in a nonpolar organic solvent. In some embodiments, the MXenes are Ti₃C₂Tₓ MXenes. In some embodiments, the MXenes and Ti₃C₂Tₓ MXenes are flakes or nanoflakes.

The present disclosure thus provides a rapid, scalable method for preparing a colloidal dispersion of two-dimensional planar MXenes in a nonpolar, organic solvent which comprises (a) dispersing a MXene in a first solvent of intermediate polarity to form a first dispersion; (b) centrifuging that first dispersion for a time and at a force sufficient to pellet the MXene; (c) removing the supernatant to leave a slurry or paste of the MXene; (d) adding a nonpolar, organic solvent and a surface capping ligand to the slurry or paste to form a mixture; and (e) sonicating and/or agitating the mixture under conditions and for a time sufficient to form a stable, colloidal dispersion of non-covalently surface functionalized MXene in the nonpolar, organic solvent.

In any of the embodiments hereof, the MXene can be selected from the group consisting of Ti₃C₂Tₓ, Ti₃CN, Ti₂C, Ti₄N₃, Mo₂TiC₂, Mo₂Ti₂C₃, Ti₂N, (Ti_{2-y}Nb_{y}) C, Mo₄VC₄, and Mo₂ScC₂, and in a preferable embodiment the MXene is Ti₃C₂Tₓ.

In some embodiments, before step (a), the method further comprises preparing a dispersion of the MXene in a polar solvent, preferably water, and centrifuging that dispersion for a time and at a force sufficient to pellet the MXene, the supernatant is removed and the resultant pellet (slurry or paste) is dispersed in the first solvent for further processing in accordance with steps (b)-(e) of the disclosure. In any of the embodiments hereof, the polar solvent has a dielectric constant greater than about 70 at 25° C.

In some embodiments, before step (a), the method further comprises mixing a dispersion of the MXene in a polar solvent, preferably water, with a sufficient amount of the first solvent to form a single liquid phase, and then processing said so-dispersed MXene by steps (b)-(e) of the disclosure. In any of the embodiments hereof, the polar solvent has a dielectric constant greater than about 50. In any of these embodiments, the volumetric ratio of the first solvent to the polar solvent ranges from about 1000:1 to about 1:100, and can be any of 1000:1, 500:1, 100:1, 50:1, 10:1, 2:1, 1:1, 1:10, 1:100 or any value in the range, depending on the miscibility of the first solvent and the polar solvent.

In any of the embodiments hereof, the concentration of the MXene in the solvent (including water (or other polar solvent), solvents with intermediate polarity, and nonpolar organic solvents ranges from about 0.01 mg/ml to about 200 mg/mL, and preferably ranges from about 0.1 mg/mL to about 50 mg/ml. In an embodiment the MXene concentration in the nonpolar solvent ranges from about 0.1 mg/ml to about 30 mg/ml or from about 0.1 mg/ml to about 10 mg/mL.

In any of the embodiments hereof, the first solvent has an intermediate polarity, i.e., a solvent with a dielectric constant of about 25 to about 70 at 25° C. In some embodiments, the first solvent is dimethylformamide (DMF), acetonitrile, N-methyl-2-pyrrolidone, dimethoxyethane, dimethyl sulfoxide or propylene carbonate. In any of the embodiments hereof, the first solvent is DMF. In some embodiments, the first solvent is miscible in water.

In any of the embodiments hereof, the capping ligand is a phosphine oxide. In some embodiments, the phosphine oxide is tri-n-alkylphosphine oxide having from 6 to 20 carbons in the n-alkyl linear chain, and preferably has 8 carbons. In an exemplary embodiment, the tri-n-alkylphosphine oxide is triocytlphosphine oxide (TOPO).

In any of the embodiments hereof, the capping ligand concentration in the nonpolar solvent ranges from about 0.001 mol/L to about 4 mol/L.

In any of the embodiments hereof, the nonpolar, organic solvent has a dielectric constant of less than about 15. The nonpolar, organic solvent can also be composed of a single solvent or multiple solvents. Examples of nonpolar, organic solvent include, but are not limited to, toluene, o-xylene, p-xylene, 1,2,-dichlorobenzene, 1-chlorobutane and the like.

In any of the embodiments hereof, sonicating can be conducted by bath sonication or by probe sonication. In an embodiment, sonicating is conducted by bath sonication. In some embodiments, sonicating is conducted for no more than about 15 minutes for solvent volumes of up to about one liter.

In any of the embodiments, sonicating is preferably done via bath sonication. In some embodiments, stable colloidal dispersions are obtained with no more than 15 minutes of bath sonication for volumes up to 1 L.

In any of the embodiments, agitating can be done in addition to sonicating or instead of sonicating. Generally vigourous agitation may be needed to form the colloidal dispersion.

In a further aspect, the disclosure provides a rapid, scalable method for preparing a colloidal dispersion of two-dimensional planar MXenes in a nonpolar, organic solvent which comprises (a) admixing a powdered MXene with a nonpolar, organic solvent and a surface capping ligand to form a mixture; and (b) sonicating or agitating the mixture under conditions and for a time sufficient to form a stable, colloidal dispersion of non-covalently surface functionalized MXene in the nonpolar organic solvent. This method encompasses any of the foregoing relevant embodiments.

Further features and advantages of at least some of the exemplary embodiments of the present invention, as well as the structure and operation of various exemplary embodiments of the present invention, are described in detail below with reference to the accompanying drawings.

### BRIEF DESCRIPTION OF THE DRAWINGS

FIG. 1 illustrates the overall process of preparing a Ti₃C₂Tₓ MXene dispersion in nonpolar organic solvents starting from a dispersion of the MXene in a first solvent of intermediate polarity.

FIG. 2 provides a space filling model depicting the surface of Ti₃C₂Tₓ MXene nanoflakes capped with trioctylphosphine oxide.

FIG. 3 optically illustrates Ti₃C₂Tₓ MXene dispersions in different nonpolar organic solvents at varying concentrations of trioctylphosphine oxide at day 0 (left panel) and at day 35 (right panel). The top images show dispersion of Ti₃C₂Tₓ MXene in water at day 0 and day 35.

FIGS. 4A-F graphically illustrate the extinction ratio (i.e., normalized by the initial extinction) for Ti₃C₂Tₓ MXene dispersions in (A) water, (B) toluene, (C) o-xylene, (D) p-xylene, (E) 1,2-dichlorobenzene and (F) 1-chlorobutane.

FIGS. 5A-F are TEM images of Ti₃C₂Tₓ MXene dispersions after being kept in (A) water, (B) toluene, (C) o-xylene, (D) p-xylene, (E) 1,2-dichlorobenzene or (F) 1-chlorobutane for more than 35 days. For panels (B) to (F), the concentration of TOPO is 0.628 mol/L. The inset of each panel depicts the electron diffraction pattern the selected area.

FIGS. 6A-E are TEM images of Ti₃C₂Tₓ MXene dispersions after being kept in (A) toluene, (B) o-xylene, (C) p-xylene, (D) 1,2-dichlorobenzene or (E) 1-chlorobutane for 1.2 years. For these panels, the concentration of TOPO is 0.628 mol/L.

FIG. 6F shows a bottle with 0.5 L a stable colloidal dispersion of 0.628 mol/L TOPO-capped Ti₃C₂Tₓ MXene in toluene after 1.2 years.

### DETAILED DESCRIPTION

Various features or the like of the methods for preparing colloidal dispersions of two-dimensional planar MXenes in nonpolar organic solvents will now be described more fully hereinafter with reference to the accompanying drawings, in which one or more features or results of the methods will be shown and described. It should be appreciated that the various features may be used independently of, or in combination, with each other. It will be appreciated that the methods as disclosed herein may be embodied in many different forms and should not be construed as being limited to the examples set forth herein. Rather, these examples are provided so that this disclosure will convey certain features of the methods to those skilled in the art.

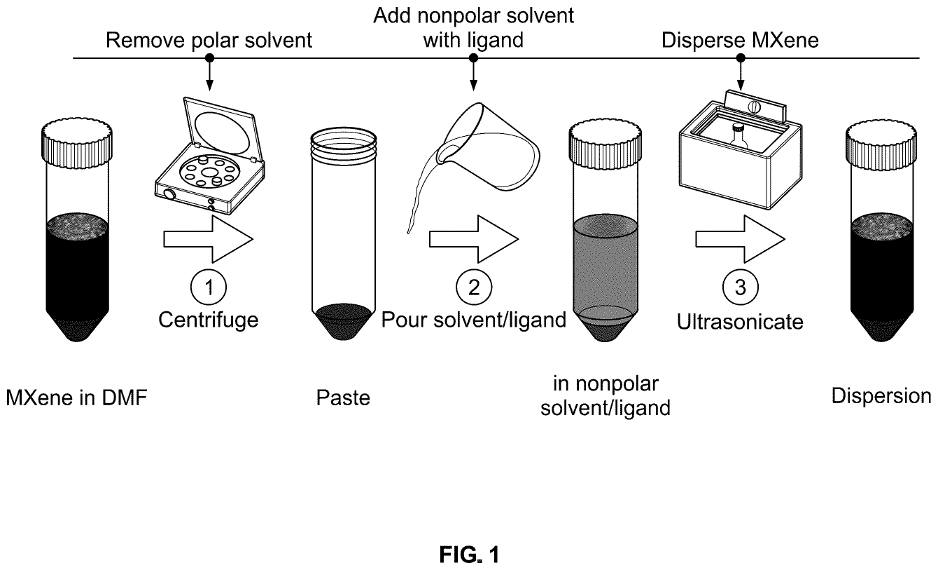

FIG. 1 illustrates a dispersion method of the disclosure in which Ti₃C₂Tₓ MXene nanoflakes are dispersed into a nonpolar organic solvent. A dispersion of Ti₃C₂Tₓ MXene nanoflakes in deionized water (DI) water is prepared by the MILD method described in Alhabeb et al. “Guidelines for synthesis and processing of two-dimensional titanium carbide (Ti3C2T x MXene).” Chemistry of Materials 29.18 (2017): 7633-7644. The DI water can be replaced (or substantially removed) using centrifugation to leave a paste. Dimethylformamide or other solvent with intermediate polarity, i.e., a first solvent, is then added to form a single liquid phase containing dispersed MXene nanoflakes. Dimethylformamide or the like is advantageous because it is miscible with both polar and nonpolar solvents. This mixture is centrifuged (step 1) and the MXene nanoflakes are recovered as a slurry or paste (with minimal amount of dimethylformamide). The slurry or paste is then dispersed into the desired nonpolar organic solvent by adding trioctylphosphine oxide solution in a nonpolar organic solvent to the slurry or paste (step2) and subjecting that mixture to ultrasonication in a bath sonicator for 15 minutes at room temperature (step3). Such action leads to the formation of the dispersion using sound waves. A dispersion is a distribution of particles of one phase in a continuous liquid phase of a different nature, assisted in this case by sound waves (>20 KHz in frequency). In the present disclosure, the method uses ultrasound and/or agitation to produce a stable dispersion of a MXene in a nonpolar organic solvent.

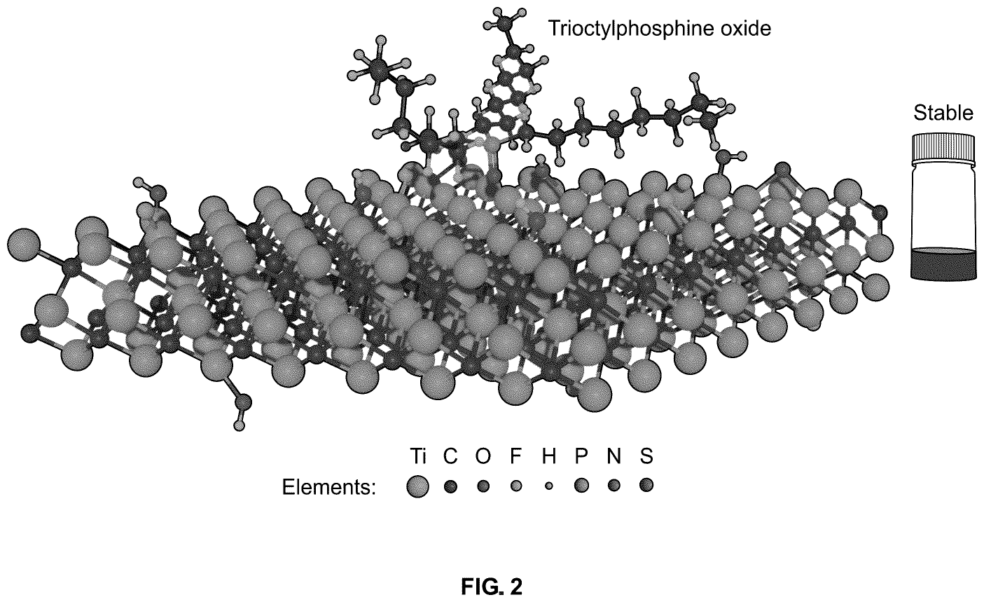

In this example, the surface of the Ti₃C₂Tₓ MXene nanoflakes is presumably capped with trioctylphosphine oxide through the interaction between the head group of trioctylphosphine oxide (O═P) and the titanium atom, resulting in the Ti₃C₂Tₓ MXene nanoflakes being covered by the nonpolar bulky tail of the trioctylphosphine oxide as shown in FIG. 2 by non-covalent coordination chemical interactions. The formation of the dative bond between ligand and nanoparticle is generally fast (in some cases it is near-instantaneous). Hence, the formation of Ti₃C₂Tₓ MXene dispersion in nonpolar organic solvents (e.g., toluene) can be achieved in 15 minutes under bath sonication at room temperature.

In accordance with the disclosure, the Ti₃C₂Tₓ MXene or another MXene can be used in the method. Other MXenes that can be used in the present methods include, but are not limited to, Ti₃CN, Ti₂C, Ti₄N₃, Mo₂TiC₂, Mo₂Ti₂C₃, Ti₂N, (Ti_{2-y}Nb_{y}) C, Mo₄VC₄, Mo₂ScC₂ and the like. The MXenes for use in the method are generally flakes or nanoflakes (the terms are used interchangeably), as single layers or multilayers, and can be prepared by methods known in the art. For example, the Ti₃C₂Tₓ MXene can be prepared by the MILD method, dispersed in water and then transferred into the nonpolar organic solvent as described herein. Alternatively, this MXene and other MXenes can be purchased and used in the method.

In some embodiments, the first solvent has an intermediate polarity, such as solvents with dielectric constants of from about 25 to about 70. A preferred first solvent is dimethylformamide (DMF). Additionally, other first solvents include, but are not limited to, acetonitrile, N-methyl-2-pyrrolidone, dimethoxyethane (DME), dimethyl sulfoxide (DMSO), propylene carbonate and the like. In general, the firest solvents can be, but are not necessarily, miscible in polar solvents, especially water. In accordance with the method, centrifugation is known in the art and the conditions therefor can readily be determined by one of ordinary skill in the art. For example, a volume of 20 ml of the Ti₃C₂Tₓ MXene dispersion in DMF can be pelleted in about 35 minutes at a force of about 5000 g. After centrifugation, the supernatant is removed by any convenient method, including decanting, pipetting or pouring to leave a pellet, slurry or paste for further processing.

In some embodiments, once the pellet, slurry or paste is obtained, the nonpolar organic solvent and the capping ligand are added and subjected to sonication or agitation (i.e., is sonicated). In an alternative embodiment, a powdered MXene is admixed directly with a nonpolar, organic solvent and a surface capping ligand to form a mixture; and that mixture is sonicated or agitated under conditions and for a time sufficient to form a stable, colloidal dispersion of non-covalently surface functionalized MXene in the nonpolar organic solvent. This method encompasses any of the relevant embodiments herein.

In any of the embodiments disclosed herein, the nonpolar organic solvent can be selected from toluene, o-xylene, p-xylene, 1,2-dichlorobenzene, 1-chlorobutane or any other such solvent with a dielectric constant less than about 15 at 25° C.

In any of the embodiments of the method, the capping ligand is a ligand that interacts with the metals or surface functionalization of the MXene sheets by noncovalent coordination. In some embodiments, the capping ligand is a phosphine oxide, and preferably, is a tri-n-alkylphosphine oxide, wherein the n-alkyl moiety has from 6 to 20 carbons in the linear chain, and preferably has 8 carbons. In an exemplary embodiment, the tri-n-alkylphosphine oxide is triocytlphosphine oxide (TOPO). A review of nanoparticle ligands, including triocytlphosphine is found in Heuer-Jungemann et al. 2019, Chem. Rev. 119:4819-4880.

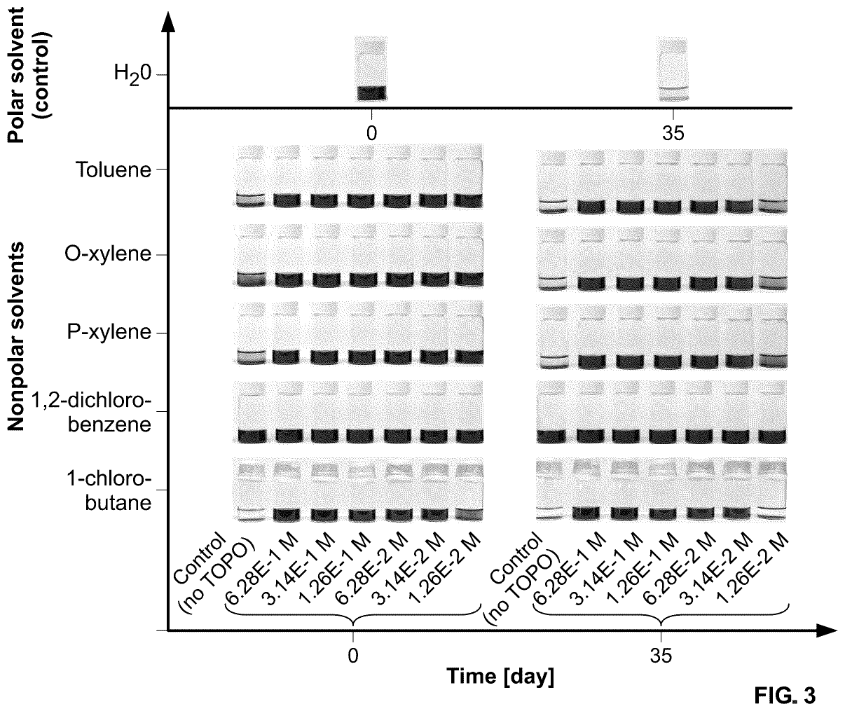

In accordance with the disclosure, the sonication and/or agitation of the MXene and capping ligand in the desired solvent is used to produce the stable colloidal dispersion of the non-covalently surface functionalized MXene in the solvent. Sonication and agitation techniques are well known in the art and the conditions therefore can be determined by those skill in the art. Sonication is interchangeably referred to herein as ultrasonication or ultrasound and includes bath sonication and probe sonication. Bath sonication is preferred. For example, the dispersions shown in FIG. 3 were prepared by bath sonication at 40 KHz.

In accordance with the methods of the disclosure, volumes up to one liter can be sonicated for up to 15 min to obtain a stable colloidal dispersion. These dispersions are stable for at least a month and in some cases, have been shown to remain stable for over a year. The methods hereof can be done with small, lab scale volumes ranging from one mL to at least one liter, as well on industrial scales such as 10 L, a 100 L or more.

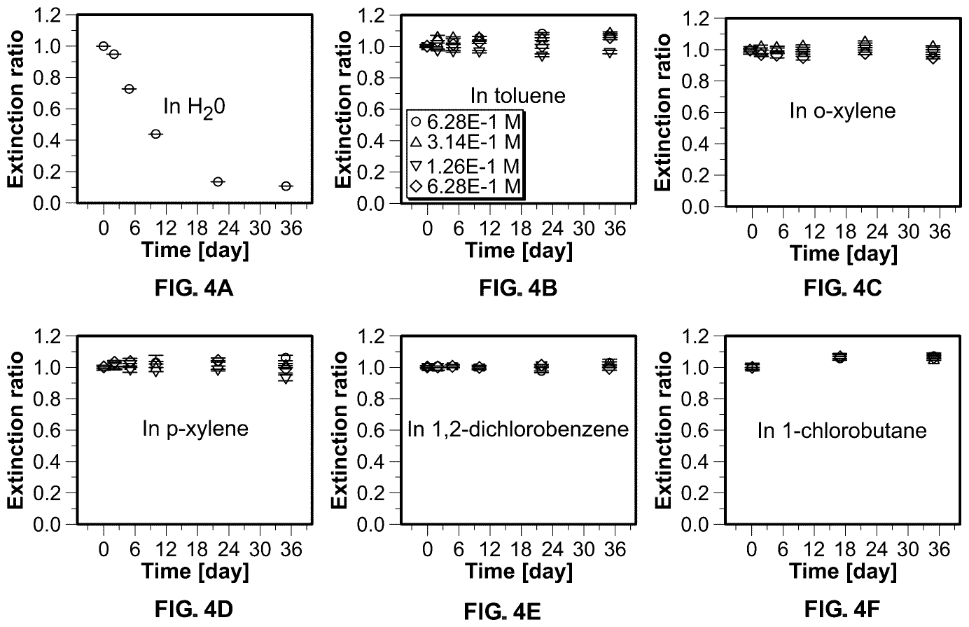

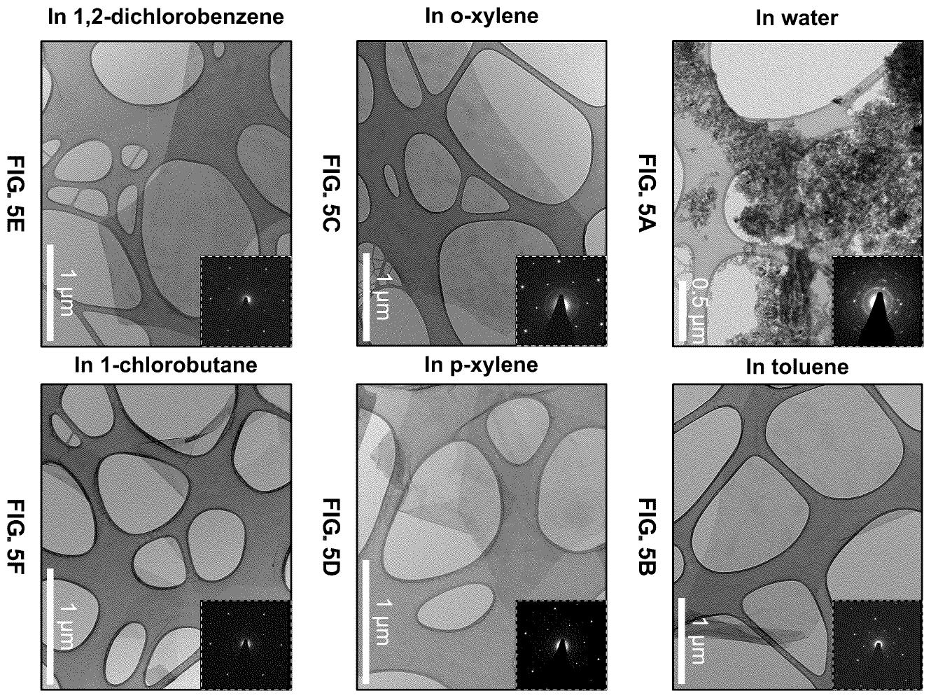

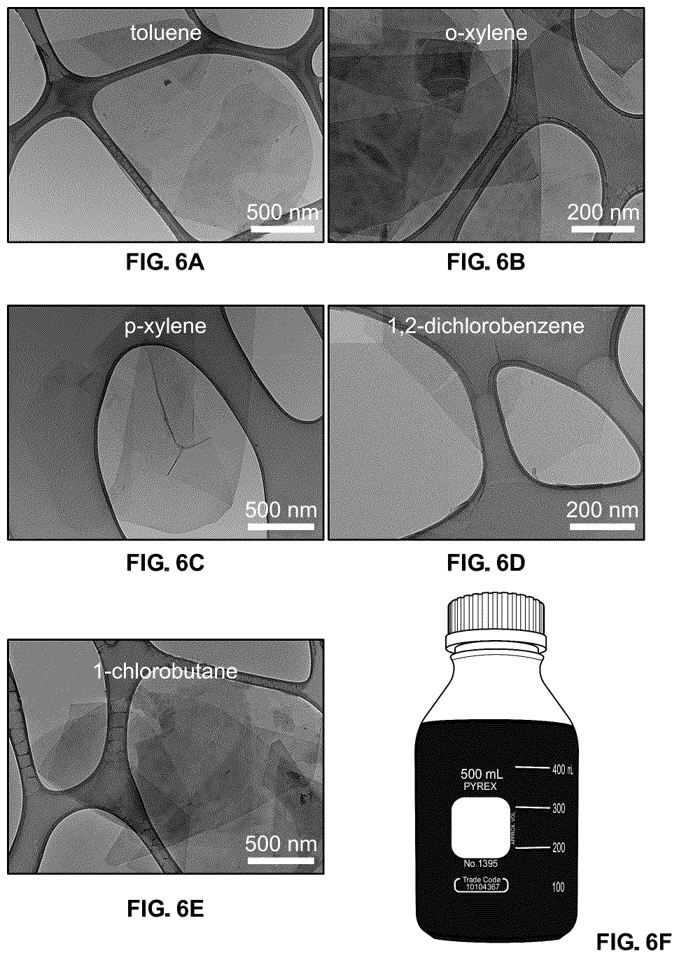

In exemplary embodiments of the disclosed method, Ti₃C₂Tₓ MXene was dispersed in different nonpolar organic solvents, including toluene, o-xylene, p-xylene, 1,2-dichlorobenzene, and 1-chlorobutane, as shown in FIG. 3, and different concentrations of TOPO. After sonication, the dispersions stayed colloidally stable for more than 35 days at high TOPO concentrations (e.g., 0.628 mol/L). The dispersed Ti₃C₂Tₓ MXene remains chemically stable for more than 35 days, as shown by the Uv-Vis-NIR results in FIG. 4. In contrast, the Ti₃C₂Tₓ MXene dispersion in DI water degraded and changed its color from black to white after 35 days (top row in FIG. 4). The chemical stability of the colloidal dispersions was also confirmed from the TEM images (FIG. 5). As shown in FIG. 5B to 5F, the edge of the MXene nanoflakes remained sharp after being kept in nonpolar organic solvent for over 35 days, indicating no degradation, whereas the MXene nanoflakes turned into smaller irregular shaped nanoparticles after being kept in DI water for over 35 days (FIG. 5A). The chemical stability of the colloidal dispersions after 1.2 years of storage are shown in FIGS. 6A-E. These TEM images show no to minimal degradation of the MXene in different nonpolar organic solvents. An image of a 0.5 liter dispersion of Ti₃C₂Tₓ MXene in toluene (0.628 mol/L TOPO) in FIG. 6F shows colloidal chemical stability after 1.2 years at rest of storage under ambient conditions. These experiments show that colloidal stability is dependent on ligand concentration. Ligand concentrations ranged from 0.0126 mol/L to 0.628 mol/L in these experiments.

The method presented in this invention is intrinsically scalable. Scalability is demonstrated by the preparation of 0.5 liter of Ti₃C₂Tₓ MXene dispersion in toluene in 15 minutes of sonication.

The invention has been described in the context of specific embodiments, which are intended only as exemplars of the invention. As would be realized, many variations of the described embodiments are possible. For example, variations in the design, shape, size, location, function and operation of various components, including both software and hardware components, would still be considered to be within the scope of the invention, which is defined by the following claims.

As would further be realized by one of skill in the art, many variations on implementations discussed herein which fall within the scope of the invention are possible. Specifically, many variations of the architecture of the model could be used to obtain similar results. The invention is not meant to be limited to the particular exemplary model disclosed herein. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A rapid, scalable method for preparing a colloidal dispersion of two-dimensional planar MXenes in a nonpolar, organic solvent which comprises
(a) dispersing a MXene in a first solvent to form a first dispersion, wherein said first solvent has an intermediate polarity;
(b) centrifuging said first dispersion for a time and at a force sufficient to pellet said MXene;
(c) removing the supernatant to leave a slurry or paste of said MXene;
(d) adding a nonpolar, organic solvent and a surface capping ligand to the slurry or paste to form a mixture; and
(e) sonicating and/or agitating said mixture under conditions and for a time sufficient to form a stable, colloidal dispersion of non-covalently surface functionalized MXene in the nonpolar organic solvent.

2. The method of claim 1, wherein said MXene is selected from the group consisting of Ti₃C₂Tₓ, Ti₃CN, Ti₂C, Ti₄N₃, Mo₂TiC₂, Mo₂Ti₂C₃, Ti₂N, (Ti_{2-y}Nb_{y}) C, Mo₄VC₄, and Mo₂ScC₂.

3. (canceled)

4. The method of claim 1, wherein the first solvent is selected from the group consisting of dimethylformamide, acetonitrile, N-methyl-2-pyrrolidone, dimethoxyethane, dimethyl sulfoxide and propylene carbonate.

5. (canceled)

6. The method of claim 1, wherein said capping ligand is a phosphine oxide.

7. The method of claim 6, wherein said phosphine oxide is tri-n-alkylphosphine oxide, wherein said alkyl moiety has from 6 to 20 carbons.

8. The method of claim 7, wherein said tri-n-alkylphosphine oxide is trioctylphosphine oxide.

9. The method of claim 1, wherein said nonpolar, organic solvent is selected from the group consisting of toluene, o-xylene, p-xylene, 1,2,-dichlorobenzene and 1-chlorobutane.

10. The method of claim 1, wherein said MXene concentration in the nonpolar solvent ranges from about 0.1 mg/mL to about 30 mg/mL.

11. The method of claim 1, wherein said capping ligand concentration in the nonpolar solvent ranges from about 0.001 mol/L to about 4 mol/L.

12. (canceled)

13. The method of claim 1, wherein sonicating is conducted for no more than about 15 minutes for a nonpolar organic solvent volume of up to about one liter.

14. The method of claim 1, before step (a), further comprises preparing a dispersion of said MXene in a polar solvent and centrifuging said dispersion for a time and at a force sufficient to pellet said MXene, and wherein said pellet is subsequently dispersed in said first solvent for further processing by steps (b)-(e).

15. The method of claim 1, before step (a), further comprises mixing a dispersion of said MXene in a polar solvent with a sufficient amount of said first solvent to form a single liquid phase, and then processing said so-dispersed MXene by steps (b)-(e).

16. (canceled)

17. A method of preparing a colloidal dispersion of Ti₃C₂Tₓ MXene in a nonpolar, organic solvent which comprises
(a) dispersing Ti₃C₂Tₓ MXene in a first solvent to form a first dispersion, wherein said first solvent has an intermediate polarity,
(b) centrifuging said first dispersion for a time and at a force sufficient to pellet said MXene,
(c) removing the supernatant to leave a slurry or paste of said MXene,
(d) adding a nonpolar, organic solvent and trioctylphosphine oxide to the slurry or paste to form a mixture; and
(e) sonicating and/or agitating said mixture under conditions and for a time sufficient to form a stable, colloidal dispersion of said MXene in the nonpolar organic solvent.

18. The method of claim 17, wherein said nonpolar, organic solvent is selected from the group consisting of toluene, o-xylene, p-xylene, 1,2,-dichlorobenzene and 1-chlorobutane.

19. The method of claim 17, wherein said MXene concentration in the nonpolar solvent ranges from about 0.1 mg/mL to about 30 mg/mL.

20. The method of claim 17, wherein said trioctylphosphine oxide concentration in the nonpolar solvent ranges from about 0.001 mol/L to about 4 mol/L.

21. (canceled)

22. The method of claim 17, wherein sonicating is conducted for no more than about 15 minutes for a nonpolar organic solvent volume of up to about one liter.

23. A rapid, scalable method for preparing a colloidal dispersion of two-dimensional planar MXenes in a nonpolar, organic solvent which comprises
(a) admixing a powdered MXene with a nonpolar, organic solvent and a surface capping ligand to form a mixture; and
(b) sonicating or agitating said mixture under conditions and for a time sufficient to form a stable, colloidal dispersion of non-covalently surface functionalized MXene in the nonpolar organic solvent.

24. The method of claim 23, wherein said MXene is selected from the group consisting of Ti₃C₂Tₓ, Ti₃CN, Ti₂C, Ti₄N₃, Mo₂TiC₂, Mo₂Ti₂C₃, Ti₂N, (Ti_{2-y}Nb_{y}) C, Mo₄VC₄, and Mo₂ScC₂.

25.-27. (canceled)

28. The method of claim 23, wherein said capping ligand is a phosphine oxide.

29. The method of claim 28, wherein said phosphine oxide is tri-n-alkylphosphine oxide, wherein said alkyl moiety has from 6 to 20 carbons.

30. (canceled)

31. The method of claim 23, wherein said nonpolar, organic solvent is selected from the group consisting of toluene, o-xylene, p-xylene, 1,2,-dichlorobenzene and 1-chlorobutane.

32. The method of claim 23, wherein said MXene concentration in the nonpolar solvent ranges from about 0.1 mg/mL to about 30 mg/mL.

33. The method of claim 23, wherein said capping ligand concentration in the nonpolar solvent ranges from about 0.001 mol/L to about 4 mol/L.

34. (canceled)

35. The method of claim 23, wherein sonicating is conducted for no more than about 15 minutes for a nonpolar organic solvent volume of up to about one liter.
